(19) United States
(12) Patent Application Publication
(10) Pub. No.: US 2025/0332818 A1
(43) Pub. Date: Oct. 30, 2025

(54) DECORATIVE PANEL, DECORATIVE COVERING, AND METHOD FOR PRODUCING SUCH A PANEL

(71) Applicant: Northann Building Solutions LLC, Elk Grove, CA (US)

(72) Inventor: Lin Li, Elk Grove, CA (US)

(73) Assignee: Northann Building Solutions LLC, Elk Grove, CA (US)

(21) Appl. No.: 18/755,649

(22) Filed: Jun. 26, 2024

(30) Foreign Application Priority Data
Apr. 29, 2024 (NL) 2037569

(51) Int. Cl. B32B 21/14; B32B 3/06; B32B 7/02; B32B 21/02; B32B 21/08; B32B 21/13; B32B 27/20; E04F 13/10; E04F 15/04

(52) U.S. Cl. CPC B32B 21/14; B32B 3/06; B32B 7/02; B32B 21/02; B32B 21/08; B32B 21/13; B32B 27/20; E04F 13/10; E04F 15/041; B32B 2250/02; B32B 2255/08; B32B 2255/28; B32B 2260/026; B32B 2307/4023; B32B 2307/412; B32B 2307/414; B32B 2307/72; B32B 2307/73; B32B 2307/7376; B32B 2451/00; B32B 2607/00; E04F 2201/0146; E04F 2201/0153; E04F 2201/043

(57) ABSTRACT

A decorative panel, in particular a floor panel, a wall panel, or a ceiling panel, include at least one core layer; at least one wood veneer layer, directly or indirectly, affixed onto a top surface of the core layer; at least one decorative top structure, directly or indirectly, applied onto a top surface of the at least one wood veneer layer and/or onto a top surface of the core layer. The decorative top structure also includes at least one decorative print layer, and at least one substantially transparent or translucent protective layer at least partially covering said decorative print layer.

### CROSS-REFERENCE TO RELATED APPLICATION

This application claims priority of the application (number 2037569) filed on Apr. 29, 2024 before the Netherlands patent office, whose disclosure is incorporated by reference in its entirety.

### TECHNICAL FIELD

Aspects of the invention generally relate to a decorative panel, in particular a floor panel, ceiling panel, wall panel, or alternative surface covering panel. Embodiments of the invention also generally relate to a decorative covering, in particular a floor covering, ceiling covering, wall covering, or alternative surface covering, comprising a plurality of decorative panels according to the invention. Embodiments of the invention further generally relate to a method for producing a decorative panel, in particular a decorative panel according to the invention.

In the field of decorative floor coverings, decorative panels are known having a polyvinyl chloride (PVC) and calcium carbonate based core layer provided with a decorative top structure on top. The decorative top structure may be composed of a printed décor layer and a protective layer covering said décor layer. These panels are also referred to as stone/plastic-composite (SPC) panels and have become increasingly popular. However, SPC flooring tends to have a firmer feel underfoot compared to HDF laminate. It produces a solid, robust sound when walked upon, which is commonly considered by most individuals as less comfortable and therefore less attractive, especially in residential settings.

### SUMMARY OF THE INVENTION

Embodiments of the present invention provide a more comfortable decorative panel.

Embodiments of the present invention provide a relatively environmental-friendly laminated decorative panel comprising an improved decorative top structure with an improved impact resistance.

Embodiments of the present invention provide a laminated decorative panel with a reduced carbon footprint.

Embodiments of the present invention provide decorative panel with improved acoustic properties.

In one example, a decorative panel according to aspects of the invention, comprising:
at least one core layer,
at least one wood veneer layer, directly or indirectly, affixed onto a top surface of the core layer,
at least one decorative top structure, directly or indirectly, applied onto a top surface of the at least one wood veneer layer and/or onto a top surface of the core layer, said decorative top structure comprising:
at least one decorative print layer, and
at least one substantially transparent or translucent protective layer at least partially covering said decorative print layer.

The panel according to embodiments of the invention provides at least one intermediate wood veneer layer positioned in between the core layer(s) and the decorative top structure. This intermediate wood veneer layer may be entirely covered and therefore hidden by the decorative top structure, but it has been found that the presence of such a natural wooden layer provides a softer feel underfoot compared to SPC panels, wherein the panel produces a somewhat softer sound when walked upon, which individuals find more comfortable and therefore more attractive, especially in residential settings. Furthermore, the acoustic properties of the panel according to the invention are better than the acoustic properties of traditional panels, such as SPC panels and/or traditional HDF laminate panels. In particular, the panel according to the invention exhibits a reduced sound transmission (due to an increased sound absorption, and moreover an improved sound reflection, which provides the panel excellent acoustic properties. Moreover, due to the presence of wood in the panel, the carbon footprint is reduced with respect to SPC panels. Due to the presence of the wood veneer layer(s), the thickness of the core layer(s) may be reduced, which is (also) favourable from an environmental point of view. Furthermore, due to the presence of at least one genuine wood layer in the panel according to the invention, the panel becomes more attractive to end consumers due to the perceived quality, as natural wood is often associated with quality and durability, due to environmental consciousness, as panels at least partially composed of natural materials like wood can appeal to consumers who prioritize environmentally friendly options, and/or due to the connection to nature as wood has a unique ability to evoke feelings of warmth, comfort, and connection to nature, which may resonate with consumers seeking a more organic or natural lifestyle.

The wood veneer may be composed of any wood type, but may at least partially composed of at least one wood chosen from the group consisting of: poplar, birch, red oak, maple, pine, spruce, and cedar. The woods are typically relatively cost efficient and suitable for use in the panel according to the invention.

The wood veneer layer may be glued on top of the core layer, for example by using a separate glue layer (adhesive layer or bonding layer). Additionally or alternatively, it is also imaginable that the wood veneer layer is fused with the core layer. This can for example be realized in case the core layer comprises a thermoplastic material, wherein the wood veneer layer(s) is/are (hot) pressed onto the core layer. Due to the elevated temperature used during this pressing step, the thermoplastic material will become soft and tacky and capable to adhere to the wood veneer.

In some embodiments, the panel comprises a plurality of wood veneer layers, directly or indirectly, affixed onto each other. The thickness of at least two wood veneer layers may be substantially identical or may mutually differ. The wood (type) of at least two wood veneer layers may be substantially identical or may mutually differ. It may be preferred that at least two wood veneer layers have mutually different, preferably perpendicular, grain directions. This typically increases the strength of the panel as such.

In some embodiments, the thickness of at least one wood veneer layer may be situated within a range of 0.25-1.0 mm, more preferably within a range of 0.5-0.65 mm. In one embodiment, the wood veneer layer may be composed out of a single piece of wood material. The thickness of at least one wood veneer layer, preferably the total thickness of a plurality of wood veneer layers if applied, may smaller than or equal to the thickness of the at least one core layer.

The thickness of the at least one core layer may be within a range of 3-11 mm, preferably within a range of 5-10 mm. In case multiple (laminated) core layers are used in the panel according to the invention, each core layer may have a thickness less then 4 mm. The lamination may be realized by means of co-extrusion and/or calendering ((hot) pressing).

In some embodiments, a part of an upper surface of the at least one wood veneer layer is left uncovered by the decorative top structure. This uncovered part of the wood veneer layer may be an exposed part (directly visible part) and/or may be provided with at least one separate coating. This uncovered part may, for example, make part of an artificial grout line or bevel of the panel, preferably situated at at least one panel edge.

In some embodiments, a part of an upper surface of the at least one wood veneer layer is visible through the decorative top structure. This implies that this part of the upper surface of the wood veneer layer is covered, and therefore protected, by the decorative top structure. This visible part of the wood veneer may be covered a partially or entirely transparent part of the décor layer, and/or may be left uncovered by the decorative print layer wherein this visible part is only covered by said at least one protective layer. This may lead to an enhanced aesthetical appearance of the panel, possibly accompanied by one or more depth effects as multiple layers (the partially visible wood veneer layer and the higher positioned decorative print layer) contribute to the decorative appearance of the panel.

In some embodiments, the at least one wood veneer layer normally exhibits a natural wood pattern. Preferably, the at least one decorative print layer defines a pattern deviating from said natural wood pattern of the at least one wood veneer layer. This synthetic decorative pattern of the decorative print layer may be at least partially in register with the wood veneer layer. This latter can be used, for example, to enhance the natural wood pattern by providing this wood pattern by exaggerating the natural wood pattern lines and/or by adding one or more (printed) wood knots and/or other irregularities to the wood pattern.

In some embodiments, the density of at least one wood veneer layer may be lower compared to the density of said at least one core layer. This difference in density is commonly favourable for the acoustic properties of the panel. A relatively-light weight wood veneer layer may be at least partially composed of softwood. Softwood generally comes from gymnosperm trees, which are typically cone-bearing and have needle-like or scale-like leaves. To this end, preferably at least one softwood chosen from the group consisting of: pine, spruce, and cedar. This materials are suitable for use in the panel according to the invention, while being cost efficient at the same time.

Additionally or alternatively, n some embodiments, the density of at least one wood veneer layer is higher compared to the density of said at least one core layer. This may for example be caused by applying a low density core layer, such as a foamed core layer. Additionally or alternatively, it is also conceivable that the wood veneer layer has a relatively high density. This may for example be the case in case the wood veneer layer is at least partially composed of hardwood, such as e.g. oak, maple, hickory, and/or cherry, and/or tropical hardwood, such as e.g. teak, mahogany, and ipe, and/or ebony. However, it is also imagined that the relatively high density of the wood veneer layer is caused by densifying the wood prior or during production. This densification can be realized by compressing wood, prior or after creating (slicing off) the wood veneer. This densified wood, which may be based on softwood and/or hardwood, may have a density of at least 1000 kg/m3, more preferably at least 1200 kg/m3, most preferably at least 1400 kg/m3.

As indicated above, in some embodiments, the at least one wood veneer layer may composed of pure wood, preferably sliced pure wood.

In some embodiments, at least one wood veneer layer may be impregnated and/or coated with a hydrophobic substance. This makes the wood veneer layer(s) and hence the panel as such more moisture resistant and therefore more durable.

In some embodiments, the thickness of the at least one wood veneer layer, and/or overall thickness of the total of wood veneer layers in case multiple wood veneer layers are applied, preferably exceeds the thickness of the at least one decorative top structure.

It may be conceivable that the at least one decorative top structure at least partially penetrates into the at least one wood veneer layer. For example, it is imaginable that at least one layer of the decorative top structure, such as the decorative print layer and/or at least one base layer positioned underneath said decorative print layer, partially penetrates into at least one wood veneer layer. This penetration will be in favour of the bonding strength between the wood veneer layer(s) and the decorative top structure.

In some embodiments, the at least one decorative print layer is directly printed onto the at least one wood veneer layer. However, it is often preferred that the decorative top structure comprises at least one back layer, preferably at least one primer layer and/or at least one white base layer, applied on top od said wood veneer layer, wherein the at least one decorative print layer is printed, preferably digitally printed, onto said base layer. This will not only improve the adhesion of decorative ink of the decorative print layer to the wood veneer, but typically also improves the colour authenticity of the decorative print layer.

In some embodiments, the decorative print layer is at least partially composed of ink, and defines at least one printed décor image (which may be a decorative pattern). The printed décor image(s) of the decorative layer(s) may be based on the CMYK colour principle where the white colour is typically provided by the surface of the white base coat (if applied). This is a 4-color setup comprising cyan, magenta, yellow and black. Mixing these together will give a colour space/gamut, which is relatively small. To increase specific colour or the total gamut spot colours may be added. A spot colour may be any colour. One or more additional colours may be applied, such as at least one additional colour selected from the group consisting of: orange, green, blue, red, white, light grey, light magenta, and light cyan. These colours may be used separately or in combinations. The colours are typically mixed and controlled by a combination of software and hardware (print engine/print heads).

In some embodiments, the at least one upper surface of the at least one decorative top structure is at least partially textured, wherein at least a part of said textured surface is aligned in register with at least a part of at least one décor image formed by the at least one decorative print layer, in particular at least one pattern defined by at least one décor image formed by the at least one decorative print layer. Preferably, at least one upper surface of at least one protective layer, in particular at least one wear layer, has a structure, which is at least partially textured, wherein at least a part of said textured surface is aligned in register with at least a part of at least one décor image formed by the at least one decorative print layer, in particular at least one pattern defined by at least one décor image formed by the at least one decorative print layer, wherein said textured surface at least partially defines a textured upper surface of the decorative panel. By applying an alignment in register, also referred to as embossing in register, a very realistic and/or artistic design and appearance of the panel can be realized. In this manner, for example, a realistic wood nerve pattern can be realized, wherein the decorated printed wood nerves (2D) are in register (in line) with the embossed printed wood nerves (3D). The same effect can, for example, be realized with a stone like design, an animal skin design, etcetera. Also, in case one or more artificial, decorative grout lines are printed, the textured surface may comprise one or more recessed channels directly above said decorative grout lines to realize a realistic appearance of the panel which is practically equal to the surface relief obtained when using real tiles and grouts.

In some embodiments, the texture of at least one textured protective layer may at least partially defined by a plurality of recesses, in particular indentations, applied in said at least one protective layer, preferably with respect to a nominal upper surface of said protective layer.

In some embodiments, the panel comprises a plurality of protective layers applied on top of each other, wherein the protective layers preferably comprises at least two wear layers and at least one protective coating defining a top surface of the panel.

In some embodiments, the at least one layer of the decorative top structure, such as at least one wear layer and/or at least one protective coating, is cured by using UV curing, and at least one, preferably other, layer of the decorative top structure is cured by using EB curing.

In some embodiments, the decorative top structure comprises: at least one, at least partially cured base layer, which may be a wear layer, provided with a plurality of indentations. This leads to a textured upper surface of the base layer (and of the panel as such). Such a layer is also referred to as a negative embossing layer. Preferably the base layer is a printed layer. Preferably the indentations are realized by my means of etching and/or printing, in particular digital printing. Etching by means of digital printing (by position-selectively printing etching ink droplets) is also imaginable, and may be considered as digital printing. Additionally or alternatively, the decorative top structure comprises at least one at least partially cured elevated pattern layer comprising a plurality of elevations. This (also) leads to a textured upper surface of the elevated pattern layer (and of the panel as such). Such a layer is also referred to as a positive embossing layer. Preferably, the elevated pattern layer is a printed, in particular a printed elevated pattern layer. Preferably, the elevations of the elevated pattern layer are printed, preferably digitally printed. As indicated above, the decorative top structure may comprise both at least one negative embossing layer and at least one positive embossing layer. A plurality of negative embossing layers and/or a plurality of positive embossing layers is also imaginable for the decorative top structure. Preferably, at least one positive embossing layer is applied on top of at least one negative embossing layer.

In some embodiments, the at least the base layer (negative embossing layer) and/or the elevated pattern layer (positive embossing layer) of the embossing structure is an Electron Beam (EB) cured layer. The combination of the negative embossing layer (at least partially formed by the indentations/recesses) and the positive embossing layer (at least partially formed by the elevations) results in a more pronounced (rough and hilly) embossing structure, wherein relatively deep embossings may be created, which leads to a more realistic appearance of the surface covering element as such. Due to the relatively deep embossings which may be created by applying the multi-level layered embossing structure, a more realistic light effect as well as a better depth effect can be obtained, wherein the colours of the décor image are typically better perceptible. Typically, an upper side of the base layer defines an embossing base level, and wherein the indentations and at least a part and/or at least a number of the elevations are situated at opposite sides of said embossing base level. It is also imaginable that the indentations and at least a part and/or at least a number of the elevations are situated at the same side of said base level.

In some embodiments, a part of the base layer is provided with said plurality of indentations, and wherein another part of the base layer is free of indentations. Hence, in this embodiment, the base layer is merely partially embossed. The elevations, of at least a part thereof and/or a number thereof, are preferably printed on the part of the base layer which is free of indentations, which leads to an increased depth effect of the embossing structure as such.

In some embodiments, the plurality of indentations of the base layer forms a discontinuous and/or a continuous indentation pattern. It is also imaginable that the plurality of indentations of the base layers forms a regular indentation pattern. Typically, the indentation pattern to be realized is strongly, or even completely, dependent on at least one décor image of the decorative layer.

In some embodiments, the base layer is a printed base layer, more preferably a digitally printed base layer. This means that the base layer, initially in liquid state, is printed either directly or indirectly on top of the decorative layer. One or more indentations may be provided in the base layer when the base layer is still in liquid state and/or one or more indentations may be provided in the base layer during and/or after curing (solidifying) the base layer. Providing one or more indentations in the liquid base layer may done by means of chemically embossing. To this end, preferably (small) droplets of an embossing liquid are position-selectively printed (sprayed) onto the liquid base layer to cause a chemical reaction between the material of the printed droplets and the still liquid base layer, wherein the subsequent reaction product changes the structure at this location of the base layer optically and/or haptically. Providing one or more indentations in the base layer during or after curing may be done by either chemical embossing (as described above) and/or by mechanical embossing e.g. by using a laser or particle beam, such as a water beam.

In some embodiments, the indentations provided in the base layer have a depth situated in between 2 micron and 100 micron, preferably situated in between 3 micron and 50 micron. Preferably, the elevations of the elevated pattern layer have a height situated in between 2 micron and 500 micron, preferably situated in between 3 micron and 300 micron. The total embossing depth is determined by the sum of the greatest indentation depth and the greatest elevation height. In case a plurality of base layers and/or a plurality of elevated pattern layers is applied, an increase of the total embossing depth can be achieved.

In some embodiments, a part from the use of EB for curing purposes, the EB may also (additionally) be used to create a texture in an upper surface of at least one layer of the covering structure. The accelerated electrons of the electron beam may be used to realize an electron bombardment of the layer to be cured, that material of said layer is pushed away, deformed, and removed (etched away) resulting in an EB caused texture. Since the resolution of this electron bombardment can be relatively high, nanotextures can be realized e.g. to refine a more coarse, preferably printed, embossing structure already realized earlier in the production process of the panel according to the invention. This will improve the look and feel of the embossing structure, and hence the look and feel of the panel as such.

In some embodiments, the at least a part of an upper surface of the embossing structure is provided with an actively roughened texture, which is typically realized by means of brushing and/or blasting.

As indicated above, in some embodiments, the decorative top structure may further comprise at least one primer layer (back layer) situated between the core and the decorative print layer. The primer may white. Preferably, the primer layer has a surface density situated between 18 g/m2 and 26 g/m2, preferably between 20 g/m2 and 24 g/m2. At least one wear layer preferably has a surface density situated between 55 g/m2 and 105 g/m2, preferably between 64 g/m2 and 96 g/m2.

As mentioned above, in some embodiments, a plurality of layers are mutually chemically bonded, preferably by means of EB curing. Preferably, the top coating is chemically bonded to at least one wear layer and/or wherein the wear layer is chemically bonded to the decorative print layer and/or wherein the wear layer is chemically bonded to the core layer and/or wherein the decorative print layer is chemically bonded to a layer underneath said decorative print layer.

In some embodiments, the at least one Electron Beam (EB) cured layer comprises a thermoplastic polymer chosen from the group consisting of: PVC, PU, and acrylic resin, such as PMMA.

In some embodiments, the top structure is partially Electron Beam cured, wherein the Electron Beam curing depth is situated in between 0.2 and 0.8 mm, preferably in between 0.3 and 0.5 mm.

In some embodiments, the visual decorative print layer may be composed solely of a decorative ink layer, but is also imaginable that the visual print layer comprises a substrate layer, such as a polymer film or paper film, onto which a decorative ink layer is printed or otherwise applied. Said visual print layer may be attached directly to the core, e.g. by fusing the visual print layer onto the core or by gluing the visual print layer to the core, wherein use can be made e.g. of a polyurethane adhesive. Optionally, an upper surface of the core is covered by at least one primer layer before attaching the visual print layer to the core, wherein the visual print layer will actually be attached to the (upper) primer layer applied to the core. As mentioned above, the decorative top structure can be partially or entirely by realized by digital printing. Optionally, the substance, in particular the ink, to realize at least a part of the wear layer and/or top coating can be free of photoinitiators. It is imaginable that the decorative top structure comprises a decorative visual print layer and a single—only one—transparent or translucent wear layer on top of said visual print layer without applying a separate top coating layer. At one wear layer, and preferably each wear layer in case a plurality of wear would be applied, may made of transparent or translucent polyurethane or, alternatively, polyvinylchloride, polypropylene, or any another suitable transparent or translucent polymer.

In some embodiments, the panel comprises a backing layer, in particular a balancing layer, which is at least partially, directly or indirectly, affixed onto a lower surface of the core layer. This backing layer contributes to the sound dampening properties of the panel, and moreover, may contribute to stabilize the shape of the core layer, and hence of the panel as such, to prevent so-called cupping of the panel.

In some embodiments, the core preferably comprises at least one natural material, preferably at least one cellulose based material, such as wood, in particular wood particles, and/or a mineral material, such as talc, chalk (calcium carbonate), and/or magnesium hydroxide. At least one core layer may be at least partially composed of HDF and/or MDF. Additionally or alternatively, at least one core layer may comprise a mixture of at least one thermoplastic material and at least one filler, in particular an inert filler, such as talc, chalk (calcium carbonate), and/or magnesium hydroxide. The thermoplastic material may e.g. be chosen from the group consisting of: polyethylene (PE), polypropylene (PP), polystyrene (PS), polyvinyl chloride (PVC), polyethylene terephthalate (PET), polyamide (PA), thermoplastic urethane (TPU), polycarbonate (PC), and ABS. For environmental and/or health reasons, it may be preferred that the core layer, and preferably the panel as such, is substantially, preferably entirely, free of PVC. Examples of further suitable fillers are leather fibers, glass particles, nylon fibres, wool, and/or other vegetable particles, in particular vegetable fibers.

In some embodiments, the panel has a modulus of elasticity is within a range of 3000-4500 MPa, preferably within a range of 3500-4250 MPa, more preferably within a range of 3800-4100 MPa.

In some embodiments, a first panel edge comprises a first coupling profile, and a second panel edge, preferably opposite to the first panel edge, comprises a second coupling profile being designed to engage interlockingly with said first coupling profile of an adjacent surface covering element, both in horizontal direction and in vertical direction, wherein the first coupling profile and the second coupling profile are preferably configured such that two of such panels can be coupled to each other by means of a lowering movement (fold-down movement). Preferably, the first coupling profile comprises:
an upward tongue,
at least one upward flank lying at a distance from the upward tongue,
an upward groove formed in between the upward tongue and the upward flank wherein the upward groove is adapted to receive at least a part of a downward tongue of a second coupling profile of an adjacent panel, and
optionally, at least one first locking element, preferably provided at a distant side of the upward tongue facing away from the upward flank,

and wherein the second coupling profile preferably comprises:
a first downward tongue,
at least one first downward flank lying at a distance from the downward tongue,
a first downward groove formed in between the downward tongue and the downward flank, wherein the downward groove is adapted to receive at least a part of an upward tongue of a first coupling profile of an adjacent panel, and
optionally, at least one second locking element adapted for co-action with a first locking element of an adjacent panel, said second locking element preferably being provided at the downward flank.

In some embodiments, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces.

In some embodiments, the panel comprises at least one third coupling profile and at least one fourth coupling profile located respectively at a third edge and a fourth edge, wherein the third coupling profile comprises:
a sideward tongue extending in a direction substantially parallel to the upper side of the core,
at least one second downward flank lying at a distance from the sideward tongue, and
a second downward groove formed between the sideward tongue and the second downward flank,

and/or wherein the fourth coupling profile comprises:
a third groove configured for accommodating at least a part of the sideward tongue of the third coupling profile of an adjacent surface covering element, said third groove being defined by an upper lip and a lower lip, wherein said lower lip is provided with an upward locking element,

wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.

In some embodiments, aspects of the invention also relate to a covering, in particular a floor covering consisting of a plurality of, preferably interconnected, panels according to the invention.

In some embodiments, aspects of the invention further relate to a method for producing a decorative panel, in particular a decorative panel according to the preceding claims, comprising the steps of:
providing a core layer
applying a wood veneer layer, directly or indirectly, on a top surface of the core layer
applying a decorative top structure, directly or indirectly, on the upper side of the core, preferably comprising the steps of:
a. applying at least one decorative print layer;
b. applying at least one substantially transparent or translucent protective layer, at least partially covering the at least one decorative print layer;
preferably curing at least one of the layers applied during step C-a) and/or C-b) by means of UV curing and/or Electron Beam (EB) curing.

### BRIEF DESCRIPTION OF THE DRAWINGS

The present disclosure may be better understood by references to the detailed description when considered in connection with accompanying drawings. The components or elements in the figures may not necessarily be to scale, emphasis instead being placed upon illustrating the principles of the invention. In the figures, like reference numerals designate corresponding parts throughout the different views.

FIGS. 1a-1e show a part of the manufacturing process according to embodiments of the invention;

FIGS. 2a and 2b show a schematic representation of a panel according to embodiments of the invention;

FIG. 3 shows another example of a decorative panel according to embodiments of the invention;

FIGS. 4a and 4b show non-limiting examples of coupling profiles according to embodiments of the present invention;

FIG. 5 shows a schematic overview of a production line for manufacturing a panel according to embodiments of the invention; and

FIG. 6 shows an exploded view of a panel according to embodiments of the invention.

### DETAILED DESCRIPTION

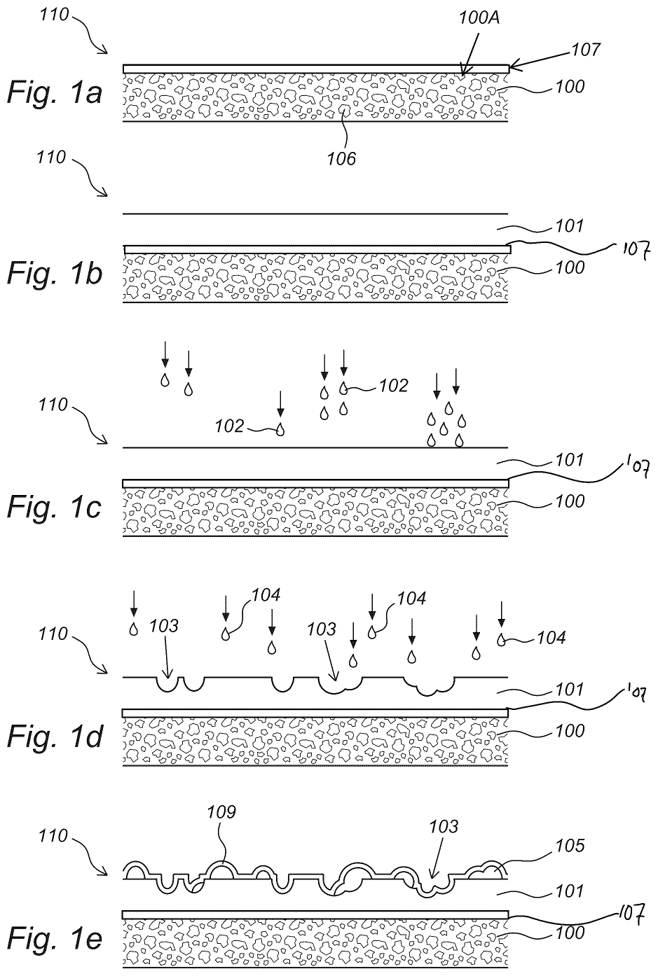

FIGS. 1a-1e show an example of subsequent steps of a method according to the present invention. FIG. 1a shows a schematic representation of a cross section of a decorative panel (110). The figure shows the core (100) of the panel (110). The core (100) comprises MDF and/or HDF material, and/or comprises at least one thermoplastic material, preferably mixed with at least one inert filler, such as calcium carbonate. The core (100) can e.g. be produced by means of extrusion or by means of hot pressing. A true wood veneer layer (107) is glued or otherwise adhered onto a top surface of the core layer (100). At least one décor image (not shown) is formed onto the upper side of the wood veneer layer (107) by means of printing, in particular digital printing. Optionally, a primer layer and/or a white back layer may be applied prior to printing the decorative print onto the upper side of the wood veneer layer. Said primer may for example be applied in an amount situated between 15 g/m2 and 30 g/m2, preferably between 20 g/m2 and 24 g/m2. It is conceivable that said primer is a UV-curable primer, which may be cured by means of a mercury light source, wherein the light energy is adjusted to any value in the range of 190 to 280 mJ. FIG. 1b show that a liquid base layer (101) is applied on the décor image. The liquid forming the liquid base layer (101) is for example a UV material. The liquid base layer (101) generally has a relatively high surface tension in order to allow precise embossing in the liquid base layer (101). The base layer (101) may at least partially cured prior to applying the embossing. FIG. 1c shows that a plurality of embossing droplets (102) is position-selectively printed on the still liquid, or partially liquid base layer (101). This is done such that the thickness of the base layer (101) changes on the positions where the embossing droplets (102) are spayed on. Alternatively or additionally, the embossing droplets (102) may inhibit the curing of the base layer (101) locally, such that after curing the base layer (101), the embossing droplets (102) remain liquid and may be removed by means of e.g., a brush. FIG. 1d shows that this results in that positions indentations (103) are formed in the liquid base layer (101) at the positions where the embossing droplets (102) are sprayed on, or removed by means of a brush as discussed above. Preferably, said indented textured surface is at least partially aligned in register with at least a part of at least one décor image formed by said decorative print layer. The plurality of indentations (103) of the base layer (101) preferably forms a discontinuous indentation pattern. Subsequently, it is conceivable, but not required, that an elevated pattern layer is formed by position-selectively printing of a plurality elevations on the base layer (101). Optionally, the elevation droplets (104) applied onto the panel (110) are shown in FIG. 1d. The pattern layer obtained via the position-selectively printing of the elevations (105) is subsequently at least partially cured. Preferably, said elevated textured surface is at least partially aligned in register with at least a part of at least one décor image formed by said decorative print layer. FIG. 1e shows the application of a finishing layer or top coating (109) is applied on top of the base layer (101) and the elevations (105). Preferably, the top coating (109) is applied in a dosage situated between 8 g/m2 and 16 g/m2, preferably 10 g/m2 and 14 g/m2. The top coating (109) may an Electron Beam curable coating, cured via Electron Beam radiation at an energy adjusted to any value in the range of 25 kGy to 45 kGy, preferably 30 kGy to 40 kGy. The finishing layer (109) is in particular cured by means of Electron Beam curing. This may provide a matt look of the surface of the panel. Alternatively or additionally, also a part of the base layer (101) and/or a part of the elevations (105) may be partially cured by means of Electron Beam curing. By using this curing technique, layers may be mutually chemically bonded together, establishing a better attachment therebetween. In particular chemical bonding between the finishing layer, or top coating (109). In general the base layer (101) may also be referred to as the wear layer (101) of the panel which preferably is substantially transparent or translucent. It is preferred that this wear layer (101) is applied in an amount situated between 60 g/m2 and 100 g/m2. The wear layer may in particular be UV-curable, by means of a mercury light source having an energy adjusted to any value in the range of 240-280 mJ. Via the steps shown in FIGS. 1a-1e, a decorative panel (110) is obtained, comprising a core (100), a wood veneer layer (or multiple wood veneer layer stacked on top of each other), and a decorative top structure affixed on the wood veneer layer. The panel (110) may possibly comprise multiple coupling profiles at different panel edges for coupling multiple panels (110). The panel (110) may also comprise a backing layer (not shown) affixed to a lower side of the core (100).

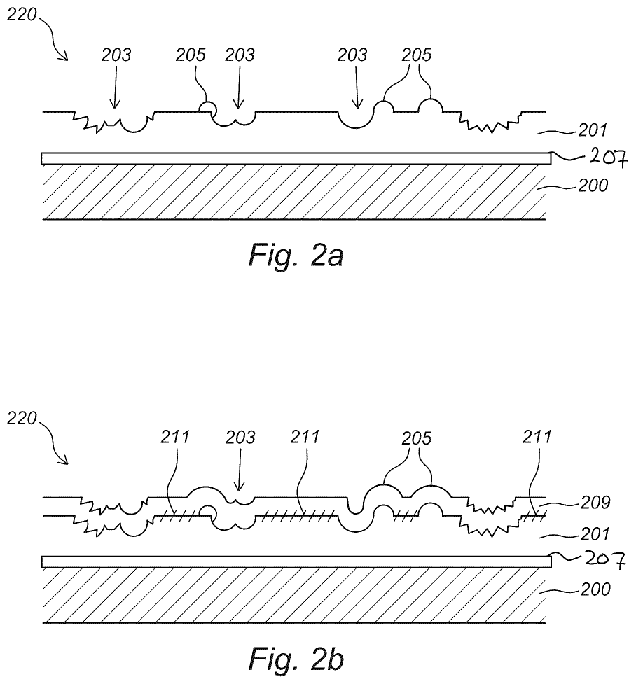

FIGS. 2a and 2b show a schematic representation of a panel (220) according to the invention. FIG. 2a shows the panel (220) prior to application of the top coating (209). The panel (220) comprises a core (200) having an upper and lower side, wherein at least one wood veneer layer (207) is applied on top of said core (200), and wherein at least one decorative top structure is provided onto said wood veneer layer (207). The wood veneer layer (207), such as a poplar layer and/or a birch layer, may glued onto and/or fused with the upper side of the core layer (200). On the upper side of wood veneer layer (207) a primer may be applied prior to applying a décor image thereon. Said primer may for example be applied in an amount situated between 15 g/m2 and 30 g/m2, preferably between 20 g/m2 and 24 g/m2. It is conceivable that said primer is a UV-curable primer, which may be cured by means of a mercury light source, wherein the light energy is adjusted to any value in the range of 190 to 280 mJ. On top of the décor image (not shown) a substantially transparent or translucent covering structure may be provided. Of said covering structure only the at least one wear layer (201) is shown in FIG. 2a. It is preferred that this wear layer (201) is applied in an amount situated between 60 g/m2 and 100 g/m2. The wear layer may in particular be UV-curable, by means of a mercury light source having an energy adjusted to any value in the range of 240-280 mJ. Said wear layer (201) may be provided with a plurality of indentations (203) and elevations (205) such that said an embossing structure is formed. At least a part of the indentations (203) may be applied by means of an embossing liquid. Said embossing liquid may for example be a UV inhibitor, which prevents curing of (a part of) the wear layer (201) under UV curing station. The uncured portion may be removed by means of a brushing action. However, indentations may also be formed by means of Electron Beam embossing. By directing at least one Electron Beam to the uncured, or partially cured, or fully cured wear layer (201) material may be locally removed via the high energy of the Electron Beam. Since this technique does not require a liquid, a bigger design flexibility may be achieved. That is, the indentations (203) may be formed with sharper corners compared to embossing liquid, yielding a more natural look. FIG. 2b shows the panel (220) after application of the top coating (209). Preferably, the top coating (209) is applied in a dosage situated between 8 g/m2 and 16 g/m2, preferably 10 g/m2 and 14 g/m2. The top coating (209) may an Electron Beam curable coating, cured via Electron Beam radiation at an energy adjusted to any value in the range of 25 kGy to 45 kGy, preferably 30 kGy to 40 kGy. The top coating (209) and wear layer (201) together defined the substantially transparent or translucent multi-layered covering structure according to the invention. In this respect, at least one of the layers of the covering structure may be formed by a substantially transparent or translucent three-dimensional embossing structure, in particular the wear layer (201) thereof. The figure further shows that a chemical bonding (211) is established between parts of the top coating (209) and the wear layer (201), this may be achieved since the top coating (209) is at least partially cured via Electron Beam curing. It is also conceivable that Electron Beam curing may be applied to, at least partially, curing the wear layer (201), such that a chemical bond may be formed between the wear layer (201) and the décor image and/or the primer and/or the core (200). Therefore, Electron Beam curing contributes to the overall integrity of the panel (220).

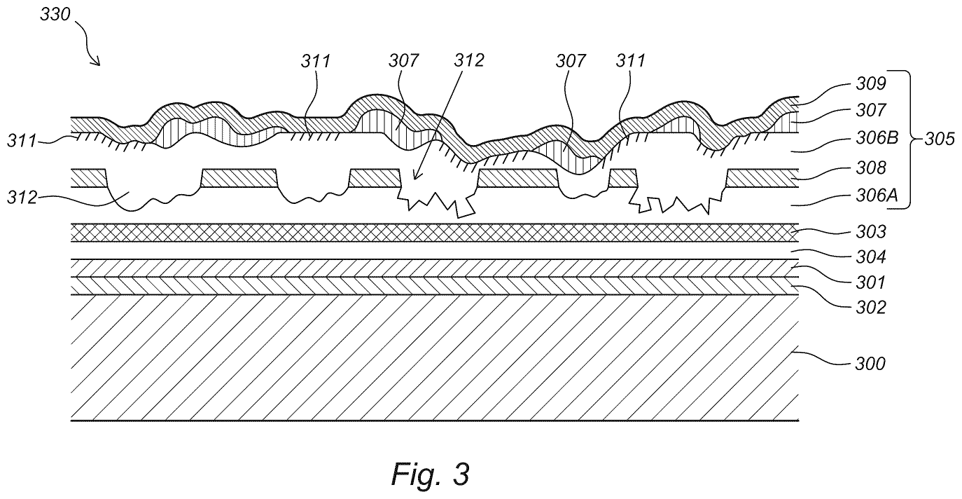

FIG. 3 shows a schematic representation of a further example of a decorative panel (330) according to the present invention. The figure show a cross section of a decorative panel (330), in particular a floor panel (330). The panel (330) comprises a core (300) provided with an upper side and a lower side. A wood veneer layer (302) is affixed to said core (300). A decorative print layer (301) is applied onto the wood veneer layer (302), wherein optionally one or more layers, such as a primer layer and a white basecoat layer are successively applied in between said wood veneer layer (302) and said decorative print layer (301). The primer layer (not shown) provides better adhesion of the decorative layer (301). Said primer may for example be applied in an amount situated between 15 g/m2 and 30 g/m2, preferably between 20 g/m2 and 24 g/m2. It is conceivable that said primer (302) is a UV-curable primer, which may be cured by means of a mercury light source, wherein the light energy is adjusted to any value in the range of 190 to 280 mJ. Optionally an intermediate layer (303) may be present on top of the printed decorative top layer (301). The intermediate layer (303) may be formed by a transparent or translucent thermoplastic layer (303). The thermoplastic layer (303) is in this non-limitative embodiment provided onto the printed decorative layer (301) by means of a hot melt glue layer (304), but may also directly be applied onto the decorative print layer (301). A substantially transparent or translucent multi-layered covering structure (305) is positioned directly or indirectly on top op of aforementioned layers (300, 301, 302, 303, 304). The covering structure (305) may in particular be a multi-layered covering structure (305) comprising at least one wear layer (306A, 306B) and at least one top coating (309), provided directly or indirectly on top of said at least one wear layer (306A, 306B). It is preferred that at least one wear layer (306A, 306B) is applied in an amount situated between 60 g/m2 and 100 g/m2. The wear layer (306A, 306B) may in particular be UV-curable, by means of a mercury light source having an energy adjusted to any value in the range of 240-280 mJ. Preferably, the top coating (309) is applied in a dosage situated between 8 g/m2 and 16 g/m2, preferably 10 g/m2 and 14 g/m2. The top coating (309) may an Electron Beam curable coating, cured via Electron Beam radiation at an energy adjusted to any value in the range of 25 kGy to 45 kGy, preferably 30 kGy to 40 kGy. The wear layer and top coating are in this particular embodiment formed by a substantially transparent or translucent three-dimensional embossing structure (305). The embossing structure (305) is a multi-layer embossing structure (305) which comprises two at least partially cured base layers (306A, 306B) provided with a plurality of indentations (312). A part of each base layer (306A, 306B) is free of indentations. The embossing structure (305) also comprises an (optional) elevated pattern layer (307) optionally formed by a plurality of elevations printed on top of the upper base layer (306B). The elevations are both printed on parts of the base layer (306B) that respectively provided with indentations and parts that are free of indentations. Despite not shown, it is also conceivable that an embossing layer is present on top of the lower base layer (306A). An optional secondary printed decorated layer (308) is affixed to the lower base layer (306A). This secondary printed decorative layer (308) is affixed to the parts of the base layer (306A) which is free of indentations. The entire panel (330) is covered with a top coating (309), in particular an Electron Beam cured top coating (309). The panel (330) benefits of the presence of two printed decorative layers (301, 308), resulting in that a unique visual pattern can be obtained. The indentations provided in the base layer (306A, 306B) may be provided via different techniques. In this non limitative embodiment, a part of the indentations (312) are provided via embossing droplets, as described with respect to FIGS. 1a-1e. Two indentations shown in FIG. 3 are however provided by means of Electron Beam application. This technique for providing negative embossing has turned out to provide more realistic indentations (312). In particular the sharp corners as present in natural wood nerves may be more realistically applied. This is due to the relatively high energy of Electron Beams, which may be used to locally disrupt the surface hence generating the indentation. By tuning the energy of the Electron Beam, different indentation depths may be achieved. Moreover, the indentations provided via Electron Beam may be established at the same time the base layer (306A, 306B) is cured. This may decrease the amount of production steps required. The figure also indicates that the top coating (309) locally established a chemical bond (311) with the adjacent layer. At least a part of said textured surface of the panel (330) may aligned in register with at least a part of at least one décor image formed by the at least one decorative print layer (301). The decorative print layer (301) may leave one or more parts of the wood veneer (302) uncovered and/or may be composed of at least partially transparent and/or translucent ink.

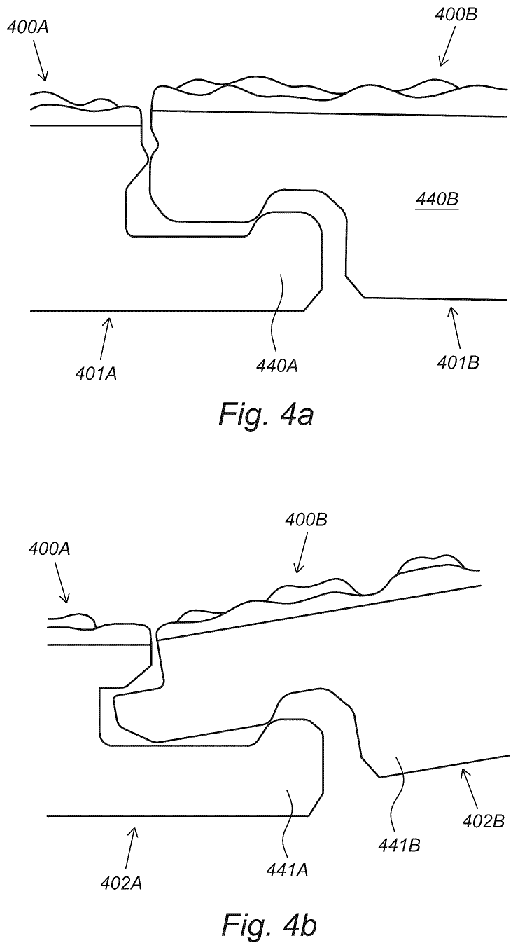

FIGS. 4a and 4b show non-limiting examples of coupling profiles (401A, 401B, 402A, 402B) used in panels (400A, 400B) according to the present invention. A first panel edge (440A) comprises a first coupling profile (401A), and a second panel edge (440B) opposite to the first panel edge (440A), comprising a second coupling profile (401B) being designed to engage interlockingly with said first coupling profile (401A) of an adjacent panel, both in horizontal direction and in vertical direction, wherein the first coupling profile (401A) and the second coupling profile (401B) are configured such that two of such panels can be coupled to each other by means of a lowering movement. This is shown in FIG. 4a. FIG. 4b show the panel comprising a third coupling profile (402A) and a coupling profile (402B) located respectively at a third panel edge (441A) and a fourth panel edge (441B). The third coupling profile (402A) and the fourth coupling profile (402B) are configured such that two of such panels (440A, 440B) can be coupled to each other by means of a turning movement, wherein, in coupled condition: at least a part of the sideward tongue of a first panel is inserted into the third groove of an adjacent, second panel, and wherein at least a part of an upward locking element of said second panel is inserted into the second downward groove of said first panel.

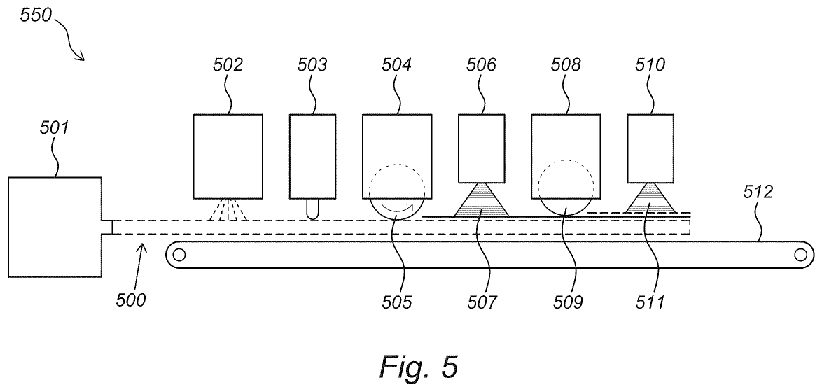

FIG. 5 depicts a simplified schematic overview of a system for manufacturing a panel according to the invention. In this non-limitative embodiment, the system (550) comprises a lamination station (501), wherein at least one wood veneer layer is affixed onto at least one core layer to form a base assembly of layers (500). This assembly of layers (500) is transported, for example by the conveyor (512), to a first station. In this case the first station (502) is formed by a primer station (502) for applying a primer layer onto the core material (500). Said primer may for example be applied in an amount situated between 15 g/m2 and 30 g/m2, preferably between 20 g/m2 and 24 g/m2. It is conceivable that said primer is a UV-curable primer, which may be cured by means of a mercury light source, wherein the light energy is adjusted to any value in the range of 190 to 280 mJ. It is also conceivable that, in case of multiple primer stations (502) are provided, that the total amount of primer applied by subsequent primer stations (502) adds up to the mentioned amount per square meter. The primer layer may provide for a better attachment of the decorative print layer. The decorative print layer is applied by a decorative printing station (503), which may apply, preferably digitally, a décor image onto the primer layer that is applied. Downstream of the printing station (503) a first coating station (504) is arranged. The first coating station (504) applies, in this case via at least one application roller (505) a first UV curable wear layer onto the slab. It is preferred that this wear layer is applied in an amount situated between 60 g/m2 and 100 g/m2. When multiple first coating stations (504) are arranged, the total amount of primer added by each of the stations (504) preferably adds up to the aforementioned amount per square meter. The first UV curable wear layer is cured via the first UV curing station (506), located downstream of the first coating station (504). Preferably said first curing station (506) cures the coating by means of a mercury light source having an energy adjusted to any value in the range of 240-280 mJ. Downstream thereof, a second coating station (508), for applying a top coating, and a second curing station (510) may be arranged. The second coating station (508) may apply, for example via a roller (509) a curable coating, preferably a coating curable via Electron Beam curing. Preferably, the top coating (109) is applied in a dosage situated between 8 g/m2 and 16 g/m2, preferably 10 g/m2 and 14 g/m2. When multiple second coating stations (508) are arranged, the total amount of top coating added by each of the stations (508) preferably adds up to the aforementioned amount per square meter.

The second curing station (510) is configured for curing the second coating, via Electron Beam radiation at an energy adjusted to any value in the range of 25 kGy to 45 kGy, preferably 30 kGy to 40 kGy. Via Electron Beam curing the top coating may be chemically bonded to the at least one wear layer applied. It is conceivable that between the first curing station (506) and the second coating station (508) a plurality of further coating and/or curing stations are arranged, for applying additional wear layers. It is also conceivable that between the first coating station (504) and the first curing station (506) an embossing station is arranged, for applying an embossing structure to the panel. The embossing structure may for example be applied as described within this application. This may for example be realized by means of an embossing liquid station, for applying position selectively an embossing liquid onto the base assembly (500), which may to this end be partially cured.

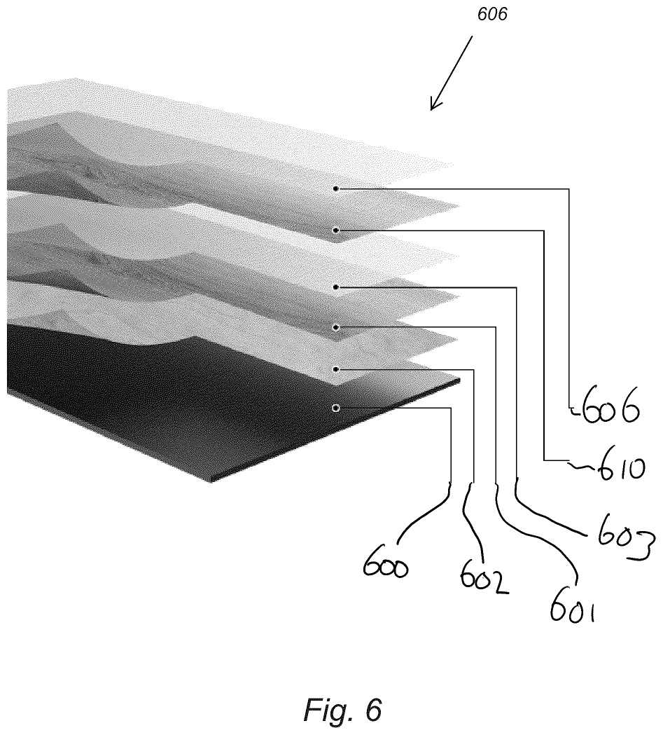

FIG. 6 depicts an exploded view of a decorative panel (607) according to the invention. The panel comprises a core layer (600) onto which at least one wood veneer layer (602) is affixed, e.g. by means of glue. A thickness of the wood veneer layer (602) may within a range of 0.25-1 mm. A thickness of the core layer (600) may within a range of 7-11 mm. Optionally, a primer layer (not shown) is applied on top of the wood veneer layer (602). On top of the wood veneer layer (602) (or on top of the primer layer (if applied)) a decorative print layer (601) is printed, in particular digitally printed. The decorative print layer (601) provides a décor image, which may be a decorative pattern. The decorative print layer (601) may be a continuous, uninterrupted layer or may be a non-continuous, interrupted layer. The decorative print layer (601) may be an opaque layer and/or a transparent and/or translucent layer. A substantially transparent or translucent protective layer (603) is applied on top of the decorative print layer (601). On top of said (first) protective layer (603) at least one textured wear layer (610) is applied to provide the panel (606) with an embossed structure, preferably at least partially aligned with the décor image of the decorative print layer (601). A protective coating (610) may applied on top.

Moreover, aspects may be expressed in one or more of the following in a claim for invention format:
1. Decorative panel, in particular a floor panel, a wall panel, or a ceiling panel, comprising:
   at least one core layer,
   at least one wood veneer layer, directly or indirectly, affixed onto a top surface of the core layer,
   at least one decorative top structure, directly or indirectly, applied onto a top surface of the at least one wood veneer layer and/or onto a top surface of the core layer, said decorative top structure comprising:
   at least one decorative print layer, and
   at least one substantially transparent or translucent protective layer at least partially covering said decorative print layer.
2. Decorative panel according to claim 1, wherein the at least one wood veneer layer is at least partially composed of at least one wood chosen from the group consisting of: poplar, birch, red oak, maple, pine, spruce, and cedar.
3. Decorative panel according to any of the preceding claims, wherein the panel comprises a plurality of wood veneer layers, directly or indirectly, affixed onto each other.
4. Decorative panel according to claim 3, wherein at least two wood veneer layers have mutually different, preferably perpendicular, grain directions.
5. Decorative panel according to any of the preceding claims, wherein the thickness of at least one wood veneer layer is situated within a range of 0.25-1.0 mm, preferably within a range of 0.5-0.65 mm.
6. Decorative panel according to any of the preceding claims, wherein the thickness of at least one wood veneer layer, preferably the total thickness of a plurality of wood veneer layers if applied, is smaller than the thickness of the at least one core layer.
7. Panel according to any of the preceding claims, wherein the thickness of the at least one core layer is within a range of 3-11 mm, preferably within a range of 5-10 mm.
8. Decorative panel according to any of the preceding claims, wherein a part of an upper surface of the at least one wood veneer layer is left uncovered by the decorative top structure.
9. Decorative panel according to any of the preceding claims, wherein a part of an upper surface of the at least one wood veneer layer is visible through the decorative top structure.
10. Decorative panel according to claim any of the preceding claims, wherein the at least one wood veneer layer exhibits a natural wood pattern, wherein the at least one decorative print layer defines a pattern deviating from said natural wood pattern of the at least one wood veneer layer.
11. Decorative panel according to any of the preceding claims, wherein the density of at least one wood veneer layer is lower compared to the density of said at least one core layer.
12. Decorative panel according to any of the preceding claims, wherein the at least one wood veneer layer comprises softwood, preferably at least one softwood chosen from the group consisting of: pine, spruce, and cedar.
13. Decorative panel according to any of the preceding claims, wherein the density of at least one wood veneer layer is higher compared to the density of said at least one core layer.
14. Decorative panel according to any of the preceding claims, wherein at least one wood veneer layer is at least partially composed of densified wood, wherein the density of said densified wood may at least 1000 kg/m3, more preferably at least 1200 kg/m3, most preferably at least 1400 kg/m3.
15. Decorative panel according to any of the preceding claims, wherein the at least one wood veneer layer is composed of pure wood, preferably sliced pure wood.
16. Decorative panel according to any of the preceding claims, wherein at least one wood veneer layer is impregnated and/or coated with a hydrophobic substance.
17. Decorative panel according to any of the preceding claims, wherein at least one wood veneer layer is glued onto a top surface of the core layer.
18. Decorative panel according to any of the preceding claims, wherein the at least one wood veneer layer is fused with the at least one core layer, preferably by hot pressing.
19. Decorative panel according to any of the preceding claims, wherein the thickness of the at least one wood veneer layer exceeds the thickness of the at least one decorative top structure.
20. Decorative panel according to any of the preceding claims, wherein the at least one decorative top structure at least partially penetrates into the at least one wood veneer layer.
21. Decorative panel according to any of the preceding claims, wherein the at least one decorative print layer is directly printed onto the at least one wood veneer layer.
22. Decorative panel according to any of the preceding claims, wherein the at least one decorative top structure comprises at least one back layer, preferably at least one primer layer and/or at least one white base layer, applied on top od said wood veneer layer, wherein the at least one decorative print layer is printed, preferably digitally printed, onto said base layer.
23. Decorative panel according to any of the preceding claims, wherein at least one upper surface of the at least one decorative top structure is at least partially textured, wherein at least a part of said textured surface is aligned in register with at least a part of at least one décor image formed by the at least one decorative print layer, in particular at least one pattern defined by at least one décor image formed by the at least one decorative print layer.
24. Decorative panel according to any of the preceding claims, wherein at least one upper surface of at least one protective layer, in particular at least one wear layer, has a structure, which is at least partially textured, wherein at least a part of said textured surface is aligned in register with at least a part of at least one décor image formed by the at least one decorative print layer, in particular at least one pattern defined by at least one décor image formed by the at least one decorative print layer, wherein said textured surface at least partially defines a textured upper surface of the decorative panel.
25. Decorative panel according to claim 24, wherein the texture of at least one textured protective layer is at least partially defined by a plurality of recesses, in particular indentations, applied in said at least one protective layer, preferably with respect to a nominal upper surface of said protective layer.
26. Decorative panel according to any of the preceding claims, wherein the panel comprises a plurality of protective layers applied on top of each other, wherein the protective layers preferably comprises at least two wear layers and at least one protective coating defining a top surface of the panel.
27. Decorative panel according to any of the preceding claims, wherein at least one protective layer of the at least one decorative top structure is a UV cured and/or EB (electron beam) cured layer.
28. Decorative panel according to any of the preceding claims, wherein the panel comprises a backing layer, in particular a balancing layer, which is at least partially, directly or indirectly, affixed onto a lower surface of the core layer.
29. Decorative panel according to any of the preceding claims, wherein the core layer comprises at least one natural material, preferably at least one cellulose based material, such as wood, in particular wood particles.
30. Decorative panel according to any of the preceding claims, wherein the core layer is at least partially composed of HDF and/or MDF.
31. Decorative panel according to any of the preceding claims, wherein the core layer comprises a mixture of at least one thermoplastic material and at least one inert filler, such as calcium carbonate.
32. Decorative panel according to any of the preceding claims, wherein the core layer, and preferably the panel as such, is substantially, preferably entirely, free of PVC.
33. Decorative panel according to any of the preceding claims, wherein the panel having a modulus of elasticity is within a range of 3000-4500 MPa, preferably within a range of 3500-4250 MPa, more preferably within a range of 3800-4100 MPa.
34. Decorative panel according to any of the preceding claims, wherein a first panel edge comprises a first coupling profile, and a second panel edge, preferably opposite to the first panel edge, comprises a second coupling profile being designed to engage interlockingly with said first coupling profile of an adjacent surface covering element, both in horizontal direction and in vertical direction,
wherein the first coupling profile and the second coupling profile are preferably configured such that two of such panels can be coupled to each other by means of a lowering movement.
35. Decorative panel according to any of the preceding claims, wherein the panel comprises at least one third coupling profile and at least one fourth coupling profile located respectively at a third edge and a fourth edge, wherein the third coupling profile comprises:
   a sideward tongue extending in a direction substantially parallel to the upper side of the core,
   at least one second downward flank lying at a distance from the sideward tongue, and
   a second downward groove formed between the sideward tongue and the second downward flank,
wherein the fourth coupling profile comprises:
   a third groove configured for accommodating at least a part of the sideward tongue of the third coupling profile of an adjacent surface covering element, said third groove being defined by an upper lip and a lower lip, wherein said lower lip is provided with an upward locking element,
wherein the third coupling profile and the fourth coupling profile are configured such that two of such panels can be coupled to each other by means of a turning movement, wherein, in coupled condition: at least a part of the sideward tongue of a first panel is inserted into the third groove of an adjacent, second panel, and wherein at least a part of the upward locking element of said second panel is inserted into the second downward groove of said first panel.
36. Covering, in particular a floor covering consisting of a plurality of, preferably interconnected, panels according to any of the preceding claims.
37. Method for producing a decorative panel, in particular a decorative panel according to any of claims 1-35, comprising the steps of:
A) providing a core layer
B) applying a wood veneer layer, directly or indirectly, on a top surface of the core layer
C) applying a decorative top structure, directly or indirectly, on the upper side of the core, preferably comprising the steps of:
a. applying at least one decorative print layer;
b. applying at least one substantially transparent or translucent protective layer, at least partially covering the at least one decorative print layer;
D) preferably curing at least one of the layers applied during step C-a) and/or C-b) by means of UV curing and/or Electron Beam (EB) curing.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application.

It will be apparent that the invention is not limited to the working examples shown and described herein, but that numerous variants are possible within the scope of the attached claims that will be obvious to a person skilled in the art. In this disclose, the expression “wood veneer” may be generalized, where appropriate, to “vegetable veneer”, being a layer which is at least partially, preferably substantially, composed of vegetable-based material, such as wood (leading to wood veneer) and/or fibers/particles/material derived from vegetables or plants, such as bamboo, palm, or coconut (leading to non-wood vegetable veneer).

The verb “comprise” and conjugations thereof used in this patent publication are understood to mean not only “comprise”, but are also understood to mean the phrases “contain”, “substantially consist of”, “formed by” and conjugations thereof.

1. A decorative panel comprising:
at least one core layer;
at least one wood veneer layer, directly or indirectly, affixed onto a top surface of the at least one core layer;
at least one decorative top structure, directly or indirectly, applied onto a top surface of the at least one wood veneer layer and/or onto a top surface of the at least one core layer, the at least one decorative top structure comprising:
at least one decorative print layer, and
at least one substantially transparent or translucent protective layer at least partially covering the at least one decorative print layer.

2. The decorative panel according to claim 1, wherein the at least one wood veneer layer comprises at least partially a material chosen from the group consisting of: poplar, birch, red oak, maple, pine, spruce, and cedar.

3. The decorative panel according to claim 1, wherein two of the at least one wood veneer layers comprise mutually different grain directions.

4. The decorative panel according to claim 1, wherein a thickness of the at least one wood veneer layer comprises within a range of 0.25 to 1.0 mm.

5. The decorative panel according to claim 1, wherein a thickness of the at least one wood veneer layer comprises within a range of 0.5 to 0.65 mm.

6. The decorative panel according to claim 4, wherein the thickness of the at least one wood veneer layer is smaller than the thickness of the at least one core layer.

7. The decorative panel according to claim 5, wherein the thickness of the at least one wood veneer layer is smaller than the thickness of the at least one core layer.

8. The decorative panel according to claim 1, wherein a thickness of the at least one core layer comprises within a range of 3 to 11 mm.

9. The decorative panel according to claim 1, wherein a thickness of the at least one core player comprises within a range of 5 to 10 mm.

10. The decorative panel according to claim 1, wherein a part of the top surface of the at least one wood veneer layer is left uncovered by the decorative top structure.

11. The decorative panel according to claim 1, wherein a part of the top surface of the at least one wood veneer layer is visible through the decorative top structure.

12. The decorative panel according to claim 1, wherein the at least one wood veneer layer exhibits a natural wood pattern, wherein the at least one decorative print layer defines a pattern deviating from said natural wood pattern of the at least one wood veneer layer.

13. The decorative panel according to claim 1, wherein a density of at least one wood veneer layer is lower than that of the at least one core layer.

14. The decorative panel according to claim 1, wherein the at least one wood veneer layer comprises softwood.

15. The decorative panel according to claim 1, wherein a density of at least one wood veneer layer is higher compared to the density of said at least one core layer.

16. The decorative panel according to claim 1, wherein the at least one wood veneer layer is at least partially composed of densified wood, wherein the density of said densified wood comprises at least 1000 kg/m3.

17. The decorative panel according to claim 16, wherein the densified wood comprises the density at least 1200 kg/m3.

18. The decorative panel according to claim 16, wherein the densified wood comprises at least 1400 kg/m3.

19. The decorative panel according to claim 1, wherein at least one wood veneer layer is impregnated and/or coated with a hydrophobic substance.

20. The decorative panel according to claim 1, wherein at least one wood veneer layer is glued onto the top surface of the at least one core layer.
